(19) United States
(12) Patent Application Publication
(10) Pub. No.: US 2008/0292167 A1
(43) Pub. Date: Nov. 27, 2008

(54) METHOD AND SYSTEM FOR CONSTRAINED RECONSTRUCTION APPLIED TO MAGNETIC RESONANCE TEMPERATURE MAPPING

(76) Inventors: Nick Todd, Salt Lake City, UT (US); Dennis L. Parker, Centerville, UT (US); Edward V.R. DiBella, Salt Lake City, UT (US); Ganesh Sharma Adluru Venkata Raja, Salt Lake City, UT (US)

Correspondence Address: FOLEY & LARDNER LLP, 150 EAST GILMAN STREET, P.O. BOX 1497, MADISON, WI, 53701-1497, US

(21) Appl. No.: 12/016,071

(22) Filed: Jan. 17, 2008

Related U.S. Application Data
(63) Continuation-in-part of application No. 11/753,380, filed on May 24, 2007.

(51) Int. Cl. G06K 9/78

(52) U.S. Cl. 382/131

(57) ABSTRACT

A method, system, and computer-readable medium are provided which perform reconstruction of an image from undersampled k-space data. Imaging data of an image area is received. The imaging data is thermal magnetic resonance imaging data in k-space generated at less than the Nyquist rate. A cost function is minimized based on an image estimate and the received imaging data. An image of the image area is defined based on the minimized cost function. The received imaging data may include current k-space data and a summation of k-space data from previous time frames. Additionally, the image may be defined before imaging data is received for a next timeframe.

### CROSS-REFERENCE TO RELATED APPLICATIONS

This application is a continuation-in-part of U.S. patent application Ser. No. 11/753,380 that was filed May 24, 2007, and fitted METHOD AND SYSTEM FOR CONSTRAINED RECONSTRUCTION OF IMAGING DATA USING DATA REORDERING, which is incorporated by reference in its entirety.

### FIELD

The field of the disclosure relates generally to imaging systems. More specifically, the disclosure relates to constrained reconstruction applied to magnetic resonance temperature mapping.

### BACKGROUND

Minimally-invasive thermal therapies are being developed in which radiofrequency currents, microwaves, lasers or high intensify focused ultrasound (HIFU) are used to preferentially kill tumor cells. Thermal therapies focus the applied energy on a small volume, causing rapid heating and, potentially, rapid dose accumulation. The thermal dose, which provides a measure of equivalent tissue damage, is given as the cumulative effect of temperature over time, as:

$${D}_{43} = \sum \text{?} Δ f \\ \text{?} \text{indicates text missing or illegible when filed} \qquad ( 1 )$$

where D₄₃ is the equivalent thermal dose at 43° C., R=0.5 is used for T>43° C., and R=0.25 is used for T<43° C. Tissue is considered to be necrosed when the thermal dose has reached 240 cumulative equivalent minutes (CEM). Because the thermal dose rate is a non-linear exponential function of temperature, high temporal resolution in temperature measurements is especially important in the area where the temperature is increasing most rapidly and to the highest values. HIFU treatments have been proposed in which large amounts of ultrasound power are deposited quickly to the region of interest, temperature Information from the MR scan is sent to a controlling computer, and the ultrasound power deposition is adjusted according to safety and efficacy concerns. In treatments such as these, the ultrasound can induce temperature changes in tissue of up to 20° C. in under 30 seconds. If tissue temperature is at 57° C. (20° C. above baseline), it will accumulate dose at a rate of 273 CEM per second. In this environment, to effectively monitor dose and use a feedback loop to control the power deposition appropriately, entire volumes need to be scanned in seconds. In order to improve the safety and efficacy of these treatments, better techniques to monitor the thermal process must be developed. Temperature changes in the tumor and the surrounding tissue must be tracked in real-time to detect the instant attainment of end-point temperatures or to calculate the accumulated thermal dose in these regions.

Magnetic resonance imaging (MRI) is capable of detecting changes in tissue due to heating or to cooling and is also able to measure temperature distributions in a variety of tissue types. MRI techniques are based on the absorption and emission of radio frequency (RF) energy by the nuclei of atoms. Typically, a target is placed in a strong magnetic field that causes the generally disordered and randomly oriented nuclear spins of the atoms to become aligned with the applied magnetic field. One or more RF pulses are transmitted into the target, perturbing the nuclear spins. As the nuclear spins relax to their aligned state, the nuclei emit RF energy that is detected by receiving coils disposed about the target. The received RF energy is processed into a magnetic resonance image of a portion of the target.

By utilizing non-uniform magnetic fields having gradients in each of three spatial dimensions, the location of the emitting nuclei can be spatially encoded so that the target can be imaged in three dimensions (3-D). The three dimensions are commonly two mutually orthogonal directions x and y defined in a plane denoted as a “slice” with a series of slices defined in a third mutually orthogonal direction z. As used herein, the x-direction is associated with a frequency-encoding (FE) direction, and the y-direction is associated with a phase-encoding (PE) direction. Generally, RF pulses having a range of frequencies are transmitted into the target, and through use of known frequency encoding (e.g., for the x-direction) and phase encoding techniques (e.g., for the y-direction), a set of MRI data is received by each of the receiver coils for each slice in the target.

MRI data provides a representation of the MRI image in the frequency domain, often called k-space domain, where kₓ and k_{y} are the spatial frequency variables in the x- and y-directions having units of cycles per unit distance. An image of the slice of the target is obtained by performing an inverse Fourier transformation of the k-space MRI data. In MRI systems having multiple receiver coils (parallel MRI), an image is reconstructed from each receiver coil, and a final image is a combination of the images from each coil. Multiple receiver coil systems can be used to achieve high spatial and temporal resolution, to suppress image artifacts, and to reduce MRI scan time.

MRI data can be acquired at the appropriate Nyquist sampling rate to avoid artifacts in the final image caused by aliasing. However, sampling at the Nyquist rate is time consuming. Thus, acquiring less data for MRI images accelerates the rate at which the images can be acquired. Unfortunately, using basic techniques to reconstruct images from undersampled data results in either low resolution or undesired image artifacts. To decrease scan time, parallel imaging can be used to exploit a difference in sensitivities between individual coil elements in a receiver array to reduce the total number of PE views that are acquired. A “view” constitutes all of the kₓ measurements for a single k_{y}. For the simplest case, a reduction factor of two, the even or odd PE views are skipped relative to the fully sampled k-space.

Skipping every other line of k-space increases the distance of equidistantly sampled k-space lines. If the maximum k_{y} is unchanged to maintain resolution, an aliased image may be generated from the k-space data. The reduction in the number of PE steps relative to the Nyquist sampling rate is known as undersampling and is characterized by a reduction factor, R. The various undersampling strategies can be divided into two groups, uniform undersampling and non-uniform undersampling. Uniform undersampling uses the equidistantly spaced distributed PE and causes aliasing in the reconstructed image. Non-uniform undersampling, also called variable-density undersampling, generally more densely samples a central region of k-space, and more sparsely samples an outer region. Parallel MRI (P-MRI) undersamples, as compared to the Nyquist sampling rate, by the reduction factor R, which may be 2 or more, to decrease the data acquisition time. The undersampling results in certain data in k-space not being acquired, and therefore not available for image reconstruction. However, dissimilarities in the spatial sensitivities of the multiple receiver coils provide supplementary spatial encoding information, which is known as “sensitivity encoding.” A fully sampled set of k-space MRI data can be produced by combining the undersampled, sensitivity-encoded MRI data received by different coils with reconstructed values for the unacquired data to create an image with removed aliasing artifacts.

Coil sensitivities can be used to reconstruct the full-FOV image in the image space domain or in the k-space domain as known to those skilled in the art. In sensitivity encoding (SENSE) reconstruction, coil sensitivity estimates determined from reference scans are applied to reconstruct images from subsequent scans in the image space domain. It is well known that SENSE reconstruction is artifactual when coil sensitivity estimates deviate from the true coil sensitivities due to subject or coil motion between reference and imaging scans. This high sensitivity to error in coil sensitivity estimates is caused by the local nature of SENSE reconstruction. In the conventional SENSE with data sampling on a regular Cartesian grid, reconstruction (de-aliasing) is done independently for each spatial location in the aliased image using local reconstruction coefficients defined by the coil sensitivity values at the corresponding spatial locations.

The proton resonance frequency (PRF) shift technique may be used to monitor heating and thermal dose accumulation during thermal treatments. PRF is currently the most accurate method for creating temperature maps and provides adequate spatial resolution. The PRF method for creating temperature maps acquires data using a fast gradient echo pulse sequence. It has been shown that the optimal signal to noise ratio (SNR) for the temperature data occurs when the echo time equals the time constant for loss of phase coherence among spins oriented at an angle to the static magnetic field due to a combination of magnetic field inhomogeneities and the spin-spin relaxation (T2*) of the tissue. However, selecting the echo time to be on the order of T2* makes the scan unacceptably long and therefore shorter echo times, generally between 5 and 15 milliseconds (msec), are used in practice. As an example, consider a two-dimensional (2D), multi-slice interleaved gradient echo sequence used at 3 Tesla. For an echo time of 10 msec, a 110 msec repetition time (TR) can accommodate 8 slices, and an imaging matrix of 128×128 can be acquired in 14 seconds. The SNR, volume coverage, and spatial resolution of such a scan is adequate, but the scan time is far too long for high temperature (>50° C.) MR-guided thermal therapy applications.

A number of strategies exist for reducing the scan times of a PRF sequence though each comes with a trade off. Echo-shifted gradient echo imaging has been proposed as a way to lengthen time-to-echo (TE) times while keeping TR times short. Using this method, scan times of 3.6 seconds per volume have been achieved, but the short TR causes substantially reduced signal in tissues with typically long (˜1 second) longitudinal relaxation time (T1) values. Parallel imaging with multiple receiver coils and use of SENSE or simultaneous acquisition of spatial harmonics reconstruction algorithms may be used. For n coils, a speed up factor of R where R≦n may be achieved, but the SNR also decreases by at least a factor of \sqrt{R}. A variety of reduced data reconstruction techniques have been proposed to decrease the scan time of dynamic imaging, including the unaliasing by fourier-encoding the overlaps using the temporal dimension (UNFOLD) technique, the k space and time broad-use linear acquisition speed-up (k-t BLAST) technique, the keyhole technique, the reduced-encoding MR imaging with generalized-series reconstruction (RIGR) technique, and the sliding window technique. However, each technique has limitations in SNR or resolution or requires a priori knowledge about the location of the changing temperature. Thus, the temporal resolution of PRF scans must be improved to meet the needs of increasingly sophisticated tumor ablation procedures that incorporate higher energy depositions, real-time feedback control, and offline trajectory optimization.

### SUMMARY

In an exemplary embodiment, a method for performing reconstruction of an image from undersampled k-space data is provided. Imaging data of an image area is received. The imaging data is thermal magnetic resonance imaging data in k-space generated at less than the Nyquist rate. A cost function, which may include a data fidelity term and a constraint term, is minimized based on an image estimate and the received imaging data. An image of the image area is defined based on the minimized cost function.

In another exemplary embodiment, a computer-readable medium is provided comprising computer-readable instructions that, upon execution by a processor, cause the processor to perform the operations of the method of performing reconstruction of an image from undersampled k-space data.

In yet another exemplary embodiment, a system is provided. The system includes, but is not limited to, a processor and the computer-readable medium operably coupled to the processor. The computer-readable medium comprises instructions that, upon execution by the processor, perform the operations of the method of performing reconstruction of an image from undersampled k-space data.

Other principal features and advantages of the invention will become apparent to those skilled in the art upon review of the following drawings, the detailed description, and the appended claims.

### BRIEF DESCRIPTION OF THE DRAWINGS

Exemplary embodiments of the invention will hereafter be described with reference to the accompanying drawings, wherein like numerals denote like elements.

FIG. 1 depicts a block diagram of an MRI data processing system in accordance with an exemplary embodiment.

FIG. 2 depicts a flow diagram illustrating exemplary operations performed by the MRI data processing system; of FIG. 1 in accordance with an exemplary embodiment.

FIG. 3 depicts a graph illustrating two-dimensional (2-D) segmentation of an image area in k-space in accordance with an exemplary embodiment.

FIG. 4a depicts the RMS error of temperature maps calculated for a region of interest about a heated region over all time frames using various values for the number of iterations and alpha in accordance with an exemplary embodiment.

FIG. 4b depicts a comparison between the image reconstructed using the full data and TCR image estimate using the undersampled data (frame 21 only), using alpha=0.05, after each iteration of the algorithm executed in accordance with an exemplary embodiment.

FIG. 5 depicts a setup of a heating experiment in accordance with an exemplary embodiment.

FIG. 6 depicts a temperature map generated from the heating experiment of FIG. 5.

FIG. 7 depicts a temperature change of one pixel over time from the heating experiment of FIG. 6 in accordance with an exemplary embodiment.

FIG. 8 depicts the root-mean-square error over a 5×11 voxel region of interest about the focal zone of heating of the heating experiment of FIG. 5 over all time points for a variety of reconstructions with a reduction factor of 4.

FIG. 9 depicts a temperature evolution of one voxel in the focal zone of heating of the heating experiment of FIG. 5.

FIG. 10 depicts the temperature calculated using a plurality of reduction factors in accordance with an exemplary embodiment subtracted from the temperature calculated using the full dataset.

FIG. 11 depicts the percentage of voxels within a region of interest about the focal zone of heating of the healing experiment of FIG. 5 that deviate from the temperature calculated using the full dataset by more than ±1.0° C. for a plurality of reduction factors in accordance with an exemplary embodiment.

### DETAILED DESCRIPTION

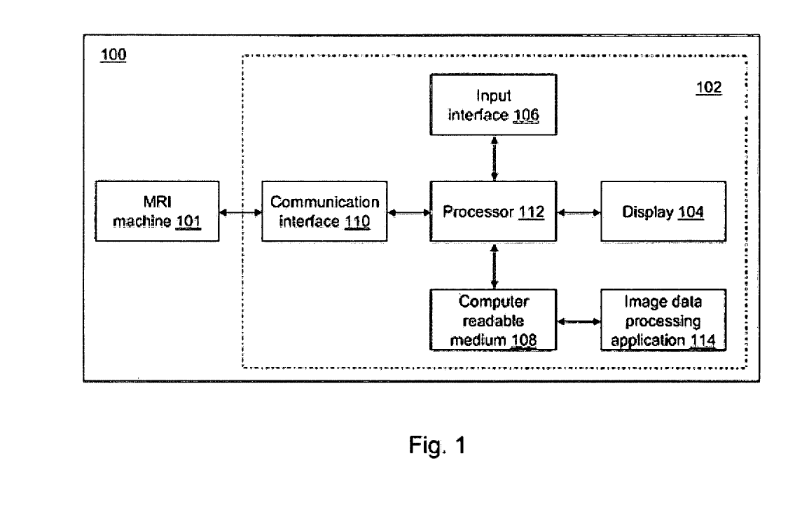

With reference to FIG. 1, a block diagram of a magnetic resonance imaging (MRI) system 100 is shown in accordance with an exemplary embodiment. MRI system 100 may include an MRI machine 101 and a computing device 102. Computing device 102 may include a display 104, an input interface 106, a computer-readable medium 108, a communication interface 110, a processor 112, and an image data processing application 114. In the embodiment illustrated in FIG. 1, MRI machine 101 generates MRI k-space data. Computing device 102 may be a computer of any form factor. Different and additional components may be incorporated into computing device 102. Components of MRI system 100 may be positioned in a single location, a single facility, and/or may be remote from one another.

Display 104 presents information to a user of computing device 102 as known to those skilled in the art. For example, display 104 may be a thin film transistor display, a light emitting diode display, a liquid crystal display, or any of a variety of different displays known to those skilled in the art now or in the future.

Input interface 106 provides an interface for receiving information from the user for entry into computing device 102 as known to those skilled in the art. Input interface 106 may use various input technologies including, but not limited to, a keyboard, a pen and touch screen, a mouse, a track ball, a touch screen, a keypad, one or more buttons, etc. to allow the user to enter information into computing device 102 or to make selections presented in a user interface displayed on display 104. Input interface 106 may provide both an input and an output interface. For example, a touch screen both allows user input and presents output to the user.

Computer-readable medium 108 is an electronic holding place or storage for information so that the information can be accessed by processor 112 as known to those skilled in the art. Computer-readable medium 108 can include, but is not limited to, any type of random access memory (RAM), any type of read only memory (ROM), any type of flash memory, etc, such as magnetic storage devices (e.g., hard disk, floppy disk, magnetic strips, . . . ), optical disks (e.g., compact disk (CD), digital versatile disk (DVD), . . . ), smart cards, flash memory devices, etc. Computing device 102 may have one or more computer-readable media that use the same or a different memory media technology. Computing device 102 also may have one or more drives that support the loading of a memory media such as a CD or DVD.

Communication interface 110 provides an interface for receiving and transmitting data between devices using various protocols, transmission technologies, and media as known to those skilled in the art. The communication interface may support communication using various transmission media that may be wired or wireless.

Processor 112 executes instructions as known to those skilled in the art. The instructions may be carried out by a special purpose computer, logic circuits, or hardware circuits. Thus, processor 112 may be implemented in hardware, firmware, software, or any combination of these methods. The term “execution” is the process of running an application or the carrying out of the operation called for by an instruction. The instructions may be written using one or more programming language, scripting language, assembly language, etc. Processor 112 executes an instruction, meaning that it performs the operations called for by that instruction. Processor 112 operably couples with display 104, with input interface 106, with memory 108, and with communication interface 110 to receive, to send, and to process information. Processor 112 may retrieve a set of instructions from a permanent memory device and copy the instructions in an executable form to a temporary memory device that is generally some form of RAM. Computing device 102 may include a plurality of processors that use the same or a different processing technology.

Image data processing application 114 performs operations associated with constructing an image from imaging data such as MRI k-space data. Some or all of the operations described may be embodied in image data processing application 114. The operations may be implemented using hardware, firmware, software, or any combination of these methods. With reference to the exemplary embodiment of FIG. 1, image data processing application 114 is implemented in software stored in computer-readable medium 108 and accessible by processor 112 for execution of the instructions that embody the operations of image data processing application 114. Image data processing application 114 may be written using one or more programming languages, assembly languages, scripting languages, etc.

MRI machine 101 and computing device 102 may be integrated into a single system. MRI machine 101 and computing device 102 may be connected directly. For example, MRI machine 101 may connect to computing device 102 using a cable for transmitting information between MRI machine 101 and computing device 102. MRI machine 101 may connect to computing device 102 using a network. MRI imaging data may be stored electronically and accessed using computing device 102. MRI machine 101 and computing device 102 may not be connected. Instead, the MRI imaging data acquired using MRI machine 101 may be manually provided to computing device 102. For example, the MRI imaging data may be stored on electronic media such as a CD, a DVD, a flash drive, etc. After receiving the MRI imaging data, computing device 102 may initiate processing of the set of images that comprise an MRI study automatically or under control of an operator of computing device 102. MRI machine 101 may be an MRI machine of any form factor, manufacture, and model.

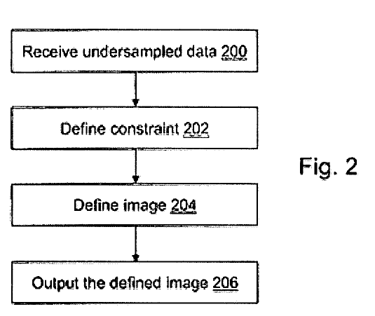

With reference to FIG. 2, exemplary operations associated with image data processing application 114 of FIG. 1 are described. Additional, fewer, or different operations may be performed, depending on the embodiment. The order of presentation of the operations of FIG. 2 is not intended to be limiting. In an operation 200, a first set of undersampled k-space data is received. For example, the k-space data may be stored at computing device 102 and a first set of k-space data selected for input to image data processing application 114 which receives the first set of k-space data as an input. As another alternative, the first set of k-space data may be streamed to computing device 102 from MRI machine 101 as the k-space data is generated by MRI machine 101 of an object being imaged. In an exemplary embodiment, MRI machine 101 is executing a gradient echo sequence. Other MRI pulse sequences may be used such as spin echo, fast spin echo, turbo spin echo, ultrafast gradient echo, hybrid echo, echo planar imaging, etc.

The k-space data may be undersampled using a variety of techniques. For example, a random or pseudo-random undersampling, a variable density undersampling, a radial undersampling, a uniform undersampling, or an interleaved undersampling pattern may be used. In an exemplary embodiment, in an interleaved undersampling, each phase encode (PE) line is acquired at some point in k-t space. For example, in an interleaved undersampling pattern with a reduction factor of 4, phase encode lines 1, 5, 9, 13, . . . may be sampled in the first time frame, lines 2, 6, 10, 14, . . . may be sampled in the second time frame, and so on.

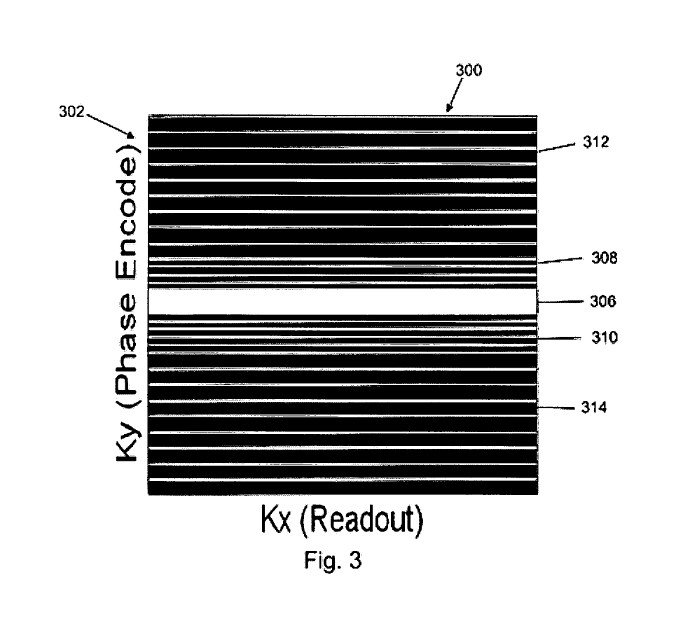

As another alternative, a variable density undersampling pattern may be used as shown with reference to FIG. 3. For example, with reference to FIG. 3, a k-space segmentation 300 is shown. In the exemplary embodiment of FIG. 3, there are five segments in a PE direction 302. There may be a greater or a lesser number of segments in PE direction 302. The five segments in PE direction 302 include a central PE segment 306. The remaining four segments are defined on a first side of central PE segment 306 and a second side of central PE segment 306, which is opposite the first side. Thus, a first PE segment 308 is indicated on the first side of central PE segment 306 and a second PE segment 310 is indicated on the second side of central PE segment 306. Additionally, a third PE segment 312 is indicated adjacent to the first PE segment 308 on the first side of central PE segment 306 and a fourth PE segment 314 is indicated adjacent to the second PE segment 310 on the second side of central PE segment 306. In an exemplary embodiment, the PE segments 306, 308, 310, 312, 314 have a variable width in the PE direction. In an exemplary embodiment, the width of the PE segments 306, 308, 310, 312, 314 increases from a low to a high spatial frequency in the PE direction.

All of the k-space lines in central PE segment 306 are acquired for each time frame. However, only a fraction of the PE lines in PE segments 308, 310, 312, 314 may be acquired for some time frames. Thus, the data in PE segments 308, 310, 312, 314 is sampled at less than a Nyquist rate. The sampling at less than a Nyquist rate may correspond with a reduction factor of 2, 3, 4, 5, 6, etc. In the exemplary embodiment of FIG. 3, a reduction factor of 3 is applied to PE segments 308, 310 and a reduction factor of six is applied to PE segments 312, 314. The same or a different reduction factor may be used in PE segments 308, 310, 312, 314. In an exemplary embodiment, the acquired PE lines are shifted in time for variable density undersampling in a similar manner to that described using interleaved undersampling. For example, if lines 1, 7, 14, . . . are acquired in the most sparse region in a first time frame, lines 2, 8, 15, . . . may be acquired in the second time frame, and so on.

In an operation 202, a constraint is defined for application to the image data during the reconstruction process. In a first exemplary embodiment, the constraint is a maximum smoothness in time function. An exemplary constraint is shown in equation (2);

$$ψ ( \text{?} ) = \sum \text{?} {‖ {∇}_{r} \text{?} ‖}_{2}^{2} \\ \text{?} \text{indicates text missing or illegible when filed} \qquad ( 2 )$$

In equation (2), the sum is over the pixels N in a time frame, ∇, is the temporal gradient operator, [symbol] represents the L₂ norm, and \tilde{m}ᵢ is the i^{th} pixel of the image estimate over time. This model assumes that no motion is present and that both the real and imaginary parts of the image data vary smoothly in time. The use of this constraint in the cost function penalizes solutions that have sharply varying time curves.

In a second exemplary embodiment, the constraint is based on a total variation in time model. This constraint is mathematically represented in equation (3):

$$ψ ( \tilde{m} ) = \sum \text{?} \sqrt{{( {∇}_{r} \tilde{m} \text{?} )}^{2} + {β}^{2}} \text{?} \\ \text{?} \text{indicates text missing or illegible when filed} \qquad ( 3 )$$

In equation (1), the sum is over the pixels N in a time frame, ∇, is the temporal gradient operator, \tilde{m}ᵢ is the i^{th} pixel of the image estimate over time, β is a small positive constant, and [symbol] represents the L1 norm. In an exemplary embodiment, β is defined based on the precision of MRI machine 101. In an exemplary embodiment, β is on the order of 10⁻⁸ to 10⁻¹⁶. This constraint also imposes a penalty on abrupt changes to the data in time, however the penalty is not as harsh as when using the maximum smoothness penalty. This constraint resolves the aliasing due to undersampling, but accommodates actual rapid changes in time in the real and imaginary image data.

In an operation 204, the image data is reconstructed to define an image of the imaged area. The standard approach to reconstructing dynamic images from full k-space data is to apply an inverse 2D Fourier transform (IFT) on each time frame of data. Acquiring less data in k-space for each time frame (k-t space) results in aliasing or artifacts in image space. If a priori information is known about the data, the information can be incorporated into an iterative reconstruction to resolve the aliasing. Using a constrained reconstruction method including an appropriate model as a constraint, removes artifacts from undersampling and preserves or increases the SNR. The standard discrete inverse Fourier reconstruction from full k-space data can be mathematically represented as m=F^{T}d, where d represents the full data acquired in k-space for different time frames, m represents the complex image data, which is the corresponding series of images for the time frames, and F^{T} represents the inverse 2D-Fourier transform on each time frame in the dynamic sequence. Applying the 2D inverse Fourier Transform to undersampled k-space data, d′, creates an image data set, m′, with aliasing. To resolve this problem and obtain a non-aliased solution, m*, a cost function is created and minimized. The terms of the cost function consist of a data fidelity term, which ensures faithfulness to the originally acquired sparse data, and a constraint term consisting of a model that is appropriate for the application and is satisfied by the full data. The data fidelity term is ∥WF\tilde{m}−d′∥₂² where F is the 2D Fourier Transform, W is a binary sparsifying function that represents which phase encoding lines have been acquired, \tilde{m} is the image estimate, and [symbol] represents the L₂ norm. The constraint term is αΨ(\tilde{m}) where Ψ is any application appropriate operator acting on the image estimate, \tilde{m}, weighted by α. Thus, the cost function that produces m* when minimized becomes

m*=argmin₂(∥WF\tilde{m}−d′∥₂²+α₁Ψ(\tilde{m})) (4)

In equation (4), α₁ represents a regularization parameter typically selected between 0 and 1.

An iterative gradient descent technique with finite forward differences may be used to minimize the cost function C. As known to those skilled in the art, many algorithms exist to minimize cost functions. For example, in another exemplary embodiment, a conjugate gradient method is used to minimize the cost function C. The complex image data may be updated iteratively according to equation (5):

m^{m+1}=m^{o}−λC⁺(m*)ᵢn=0, 1, 2, (5)

In equation (5), n represents the iteration number and λ is the step size of the gradient descent method. In an exemplary embodiment, λ is 0.5 or could be determined at each iteration with a line search. The initial estimate for m^{o} may be all zeroes. In another exemplary embodiment, the initial estimate for m⁰ may be defined as the series of images obtained by computing the IFT on each different frame of acquired sparse data d′. In yet another exemplary embodiment, the initial estimate for m⁰ may defined using a sliding window to support faster convergence. Other initialization methods may be used.

When this algorithm is applied for reconstructing dynamic contrast enhanced cardiac imaging, data can be acquired for all time frames and the reconstruction done jointly using the entire lime curve for each pixel. This is not the case when the application is temperature mapping as the images need to be produced and available in real time. Thus, only the present and past points of the time curve can be used in the reconstruction algorithm. Depending on the application, it may also be acceptable to use one “future” time point in the reconstruction algorithm, effectively delaying the availability of the temperature maps by one acquisition cycle. For example, when reconstructing time frame N, o time frames: . . . N−2, N−1, N, and N+1 are used.

The real time requirements of temperature monitoring also impose limitations on the computation time of the algorithm. For the technique to be useful, it should be capable of reconstructing the images in a time that is less than the scan time of each acquisition. It is therefore important that the initialization be chosen carefully and that the minimization process is computationally efficient. In an exemplary embodiment, the minimization is initialized using a sliding window approach. When using the algorithm to calculate the final image space data, m*, the initial k-space data, d′, is comprised of the present k-space data and a summation of k-space data from previous time frames that is needed to create a full k-space. For example, when time frame 16 is being reconstructed, the k-space data from a basic interleaved undersampling scheme may only contain phase encode lines 4, 8, 12, . . . . The sliding window initialization creates a full k-space by adding the k-space data from time frames 15 (which contains PE lines 3, 7, 11, . . . ), 14 (which contains PE lines 2, 6, 10, . . . ), and 13 (which contains PE lines 1, 5, 9, . . . ) to the data from time frame 16. In this way, the k-space data used initially in the reconstruction algorithm includes data for all PE lines, although some fraction of the data is from previous time frames. In an exemplary embodiment, the first time frame is fully sampled, so that a full k-space data set is used to initialize the process and subsequent time frames are undersampled. The most current k-space data from previous time frames is used to fill in the missing PE lines of the current time frame.

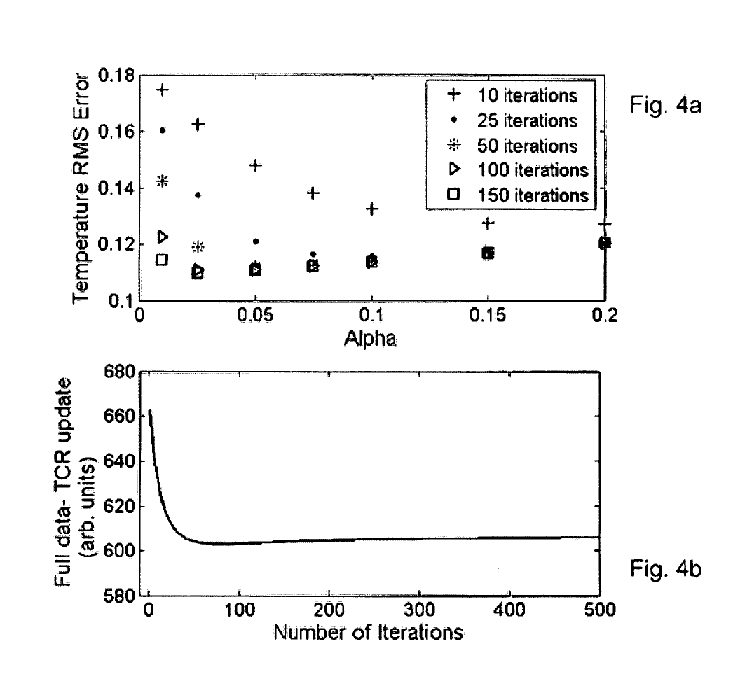

The weighting factor, α₁, is selected such that there is a good balance between fidelity to the acquired data and satisfaction of the constraint. The weighting factor for the constraint term and the number of iterations for the algorithm are selected to ensure that the best reconstruction results are obtained in the most time efficient manner. In an exemplary embodiment, to determine these parameters, images were reconstructed using the algorithm and a sliding window initialization with various alpha's and numbers of iterations. The algorithm was applied to data from an ex vivo heating experiment with a reduction factor of three and using the maximum smoothness constraint. Of course, the algorithm also could be applied to data from cooling experiments. Temperature maps were made from the TCR data and the root mean square (RMS) error was calculated from a region of interest (ROI) about the region of heating. With reference to FIG. 4a, a plurality of curves showing the temperature RMS error as a function of alpha for a number of iterations of 10, 25, 50, 100, and 150 are shown. To see the convergence of the algorithm as the number of iterations is increased, the TCR image update was subtracted from the full data image after each iteration and the absolute value of this difference was summed over all pixels. With reference to FIG. 4b, a curve of this value is shown for the reconstruction of time frame 21 using alpha=0.05 as a function of the number of iterations. If too many iterations are done or too large an alpha value is used, the algorithm can over-smooth the data. Alpha was chosen to be 0.05 for the maximum smoothness in time constraint and 100 iterations were used. Similar analysis was performed to determine the optimal parameters when using larger reduction factors and for the TCR technique using the total variation in time constraint.

In an operation 206, the image may be presented to a user of computing device 102. The operations of FIG. 2 may be repeated for multiple time frames and/or multiple slices of data. Additionally, the image data may be processed to generate a temperature change, a temperature, a dose accumulation, or a thermal dose of an area of interest which may be a single pixel or voxel or a plurality of pixels or voxels. The information may be presented to a user in the form of a curve as a function of time or may be presented as a numerical value.

Experiments were performed using a three Tesla, Simens TIM Trio scanner (Siemens Medical Solutions, Erlangen, Germany). Data was acquired using a fast spoiled gradient echo sequence with the following parameters: TR=65 msec, TE=8 msec, a 128×128 acquisition matrix, a 288×288 millimeter (mm) field-of-view (FOV), five slices, a flip angle of 20°, and 6/8 partial phase Fourier. With these parameters each volume with voxel size 2.3×2.3×3.0 mm³ could be acquired in 6.2 seconds. All phase encode lines were acquired at each time frame.

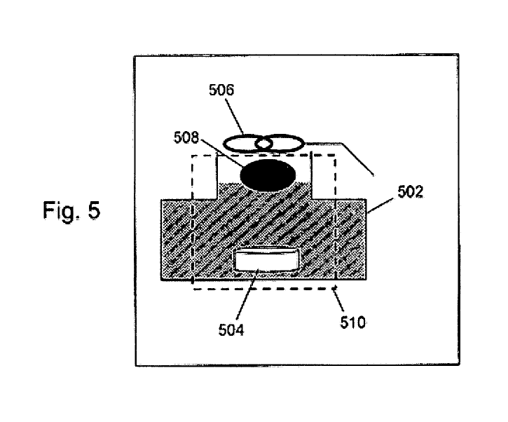

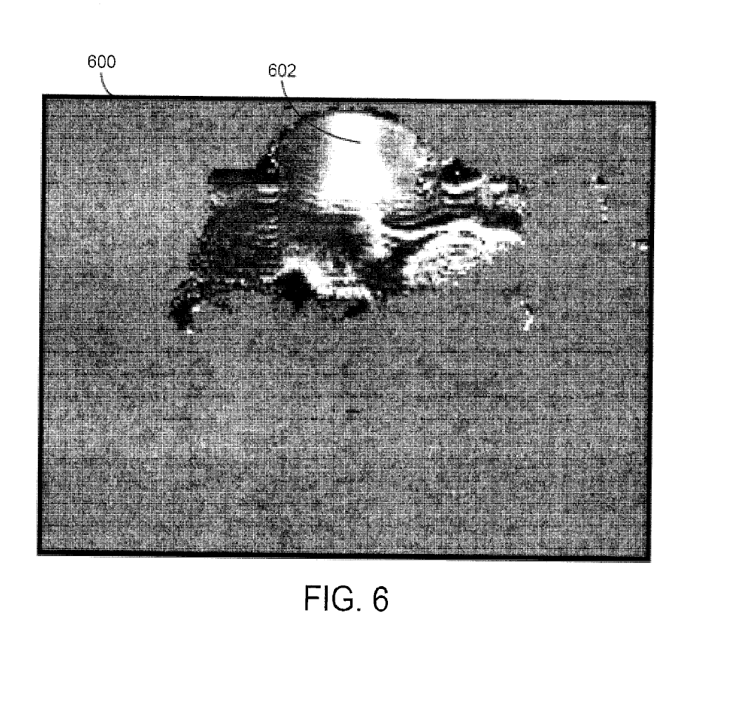

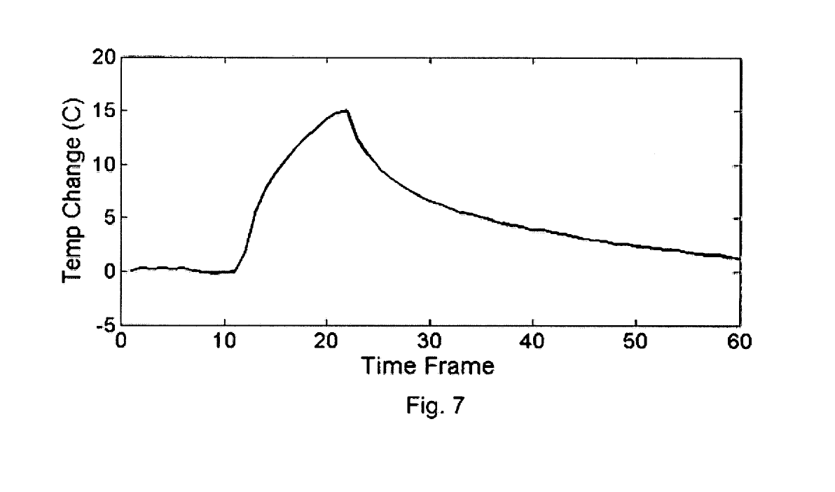

A heating experiment was performed using an ex vivo porcine tissue sample. With reference to FIG. 5, a 256-element MRI compatible phased-array ultrasound transducer 504 (IGT, Bordeaux, France) was housed in a bath 502 of deionized and degassed water with the tissue 508 situated above it. An in-house fabricated two-channel surface coil 506 was positioned just above the tissue 508 for better image SNR. The entire unit fit inside the bore of the magnet and heating was performed simultaneously with MRI image acquisition with no apparent artifacts. A FOV 510 is indicated over the experiment setup. The ultrasound power was controlled externally via a controller computer. During the porcine tissue heating experiment, ten images were acquired with no heating and then heating was applied continuously over the next ten acquisitions. Heating was turned off and an additional 40 scans were made as the tissue cooled. With reference to FIG. 6, a temperature map 600, with the colors inverted, is shown including an indication of a focal zone 602 of the heating. With reference to FIG. 7, a temperature change of one pixel from the focal zone over time is shown.

With every PE line acquired for each time frame, the k-space data was sparsified according to two different schemes. The first undersampling pattern used a simple interleaved design. In this scheme, for a reduction factor of 4, for example, PE lines 1, 5, 9, . . . are sampled in the first time frame, lines 2, 6, 10, . . . are sampled in the second time frame and so on. As an alternative approach, a variable density sampling pattern, as shown with reference to FIG. 3, was also implemented. Eight phase encode times in central PE segment 306 were acquired for every time frame. First PE segment 308 and second PE segment 310, were sampled in an interleaved fashion with high density. Third PE segment 312 and fourth PE segment 314 were sampled in an interleaved fashion with tower density. With reference to FIG. 3, an example sampling scheme for a reduction factor of four is shown in which the sampling density in first PE segment 308 and second PE segment 310 is every third line, and the sampling density in third PE segment 312 and fourth PE segment 314 is every sixth line.

Temperature maps were created from all sets of complex image data by computing the phase angle between pixels at adjacent time points and then converting the phase difference, Δφ, to temperature difference, ΔT, using the relation

$$Δ T = \frac{Δφ}{αγ {B}_{0} T \text{?} \text{?}} \\ \text{?} \text{indicates text missing or illegible when filed} \qquad ( 4 )$$

Here T_{E} is the echo time, γ is the gyromagnetic ratio, B₀ the main field strength, and for all calculations the value of the chemical shift coefficient, α, was assumed to be −0.01 ppm/° C. Two different types of analysis were performed. The first analysis involved comparing two different undersampled data reconstruction techniques—for example TCR versus sliding window or TCR with the maximum smoothness constraint versus TCR with the total variation constraint. In this case, an ROI was chosen around the focal zone and root-mean-square errors (RMSE) of the temperatures were calculated for all pixels over time for each technique. For this purpose, temperature error was defined as the deviation from the full data temperature. The RMSE of each pixel within the ROI was averaged to obtain a mean RMSE for each data set. The standard deviations of the RMSE for these data sets were calculated from a region of tissue in which no heating occurred. A Student's t-test was used to determine if the mean error of one technique was larger than the other by a statistically significant amount. The second kind of analysis involved comparing the performance of one TCR reconstruction technique on undersampled data against the standard inverse Fourier Transform technique on fully sampled data. In this case, the temperature data was analyzed to determine the extent to which the temperatures calculated from the TCR images differed from the temperatures calculated from the full data images. This was done by comparing temperature time curves of voxels in the focal zone, subtracting the TCR temperature from the full data temperature to create temperature difference maps for all time frames, and determining what percentage of TCR temperature voxels in a ROI about the focal zone differed by more than ±1.0° C. from the full data temperature.

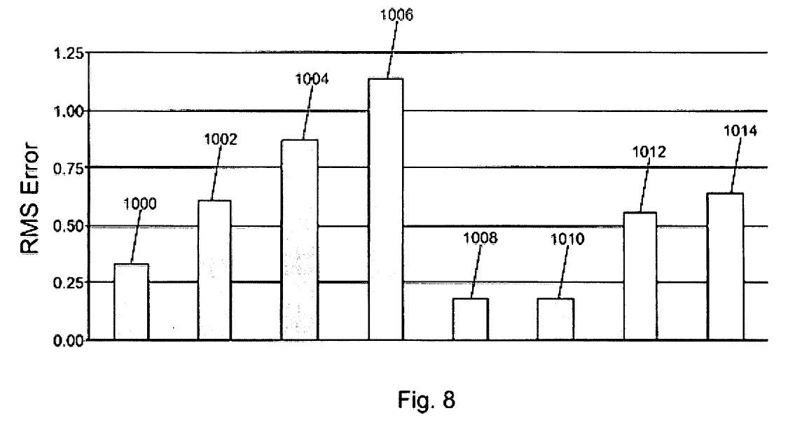

The TCR reconstruction algorithm was applied to the data from the porcine tissue heating experiment. Variations of the algorithm were compared using the RMS error of the temperature, as described above using a data reduction factor of four and shown in FIG. 8. A first value 1000 represents the RMS error resulting using only past data, the variable density undersampling, and the maximum smoothness constraint. A second value 1002 represents the RMS error resulting using only past data, the variable density undersampling, and the total variation constraint. A third value 1004 represents the RMS error resulting using only past data, the interleaved density undersampling, and the maximum smoothness constraint. A fourth value 1006 represents the RMS error resulting using only past data, the interleaved density undersampling, and the total variation constraint. A fifth value 1008 represents the RMS error resulting using past data plus one “future” time frame, the variable density undersampling, and the maximum smoothness constraint. A sixth value 1010 represents the RMS error resulting using past data plus one “future” time frame, the variable density undersampling, and the total variation constraint. A seventh value 1012 represents the RMS error resulting using past data plus one “future” time frame, the interleaved density undersampling, and the maximum smoothness constraint. A eighth value 1014 represents the RMS error resulting using past data plus one “future” time frame, the interleaved density undersampling, and the total variation constraint. Applying the Student's t test to the data confirms that the variable density sampling scheme outperforms the interleaved sampling scheme and that including one “future” time frame in the algorithm provides more accurate temperature information than using only present and past data (P<0.01 in both cases). In the case of this smooth heating experiment, the maximum smoothness constraint and the total variation constraint were not statistically different.

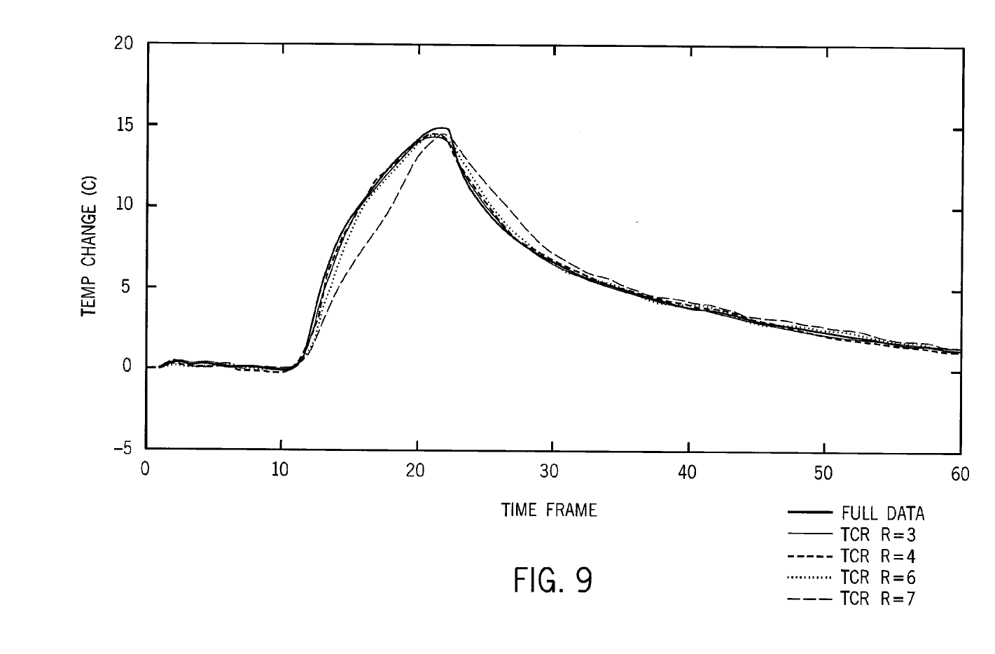

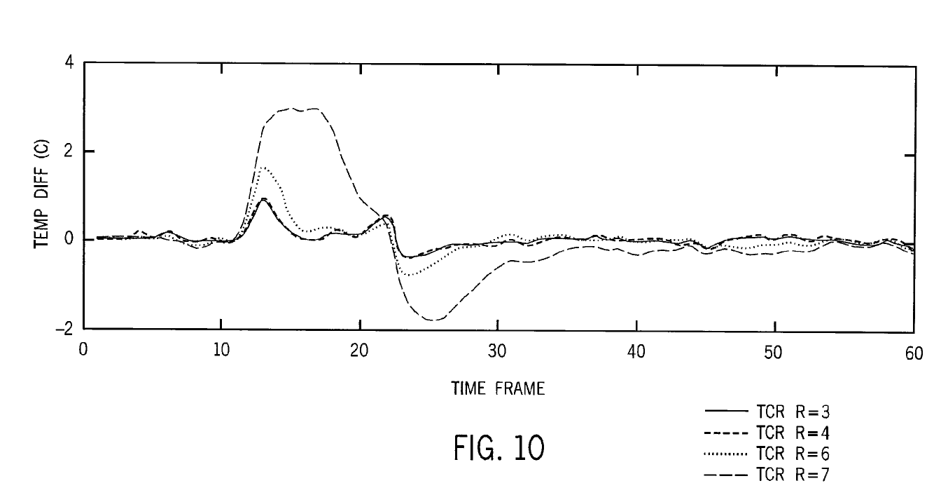

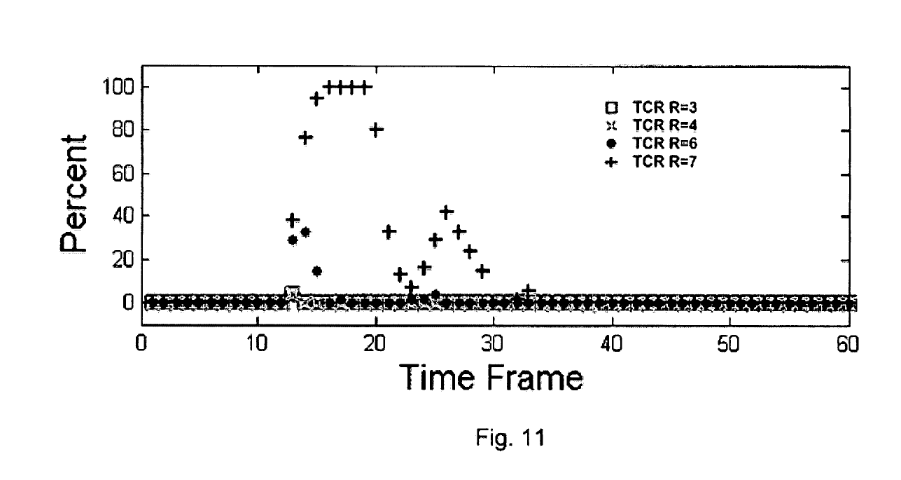

Using variable density sampling, the maximum smoothness constraint, and one “future” time frame in the algorithm, reconstructions with increasing data reduction factors were performed. The results are shown in FIGS. 9-11. FIG. 9 shows temperature versus time curves for a voxel at the focal point of the heating for a plurality of reduction factors (3, 4, 6, and 7) and for the full data. To display the deviation of the TCR data from the full data more clearly the difference between these time curves (full data−TCR data), is shown in FIG. 10 for the reduction factors 3, 4, 6, and 7. FIG. 11 shows the percentage of TCR temperature points within a 5×11 ROI about the region of heating that deviate by more than ±1.0° C. from the full data temperature for every time frame. Up to a reduction factor of four, the TCR algorithm can produce temperature information that very closely matches the temperatures calculated from the full data. When using a data reduction factor of six, some errors start to emerge, however they are small enough that they would be acceptable, especially if imaging speed is more important than temperature accuracy. The algorithm breaks down when reduction factors of 7 and higher are used. In this regime, errors of more than 2° C. emerge and the TCR temperatures from the entire focal zone deviate from the full data temperature by more than 1° C. when the temperature is changing most rapidly.

The word “exemplary” is used herein to mean serving as an example, instance, or illustration. Any aspect or design described herein as “exemplary” is not necessarily to be construed as preferred or advantageous over other aspects or designs. Further, for the purposes of this disclosure and unless otherwise specified, “a” or “an” means “one or more”. The exemplary embodiments may be implemented as a method, machine, or article of manufacture using standard programming and/or engineering techniques to produce software, firmware, hardware, or any combination thereof to control a computer to implement the disclosed embodiments.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The functionality described may be implemented in a single executable or application or may be distributed among modules that differ in number and distribution of functionality from those described herein. Additionally, the order of execution of the functions may be changed depending on the embodiment. The embodiments were chosen and described in order to explain the principles of the invention and as practical applications of the invention to enable one skilled in the art to utilize the Invention in various embodiments and with various modifications as suited to the particular use contemplated. It is intended that the scope of the invention be defined by the claims appended hereto and their equivalents.

What is claimed is:

1. A system for performing image reconstruction of undersampled image data, the system comprising:
a processor; and
a computer-readable medium operably coupled to the processor, the computer-readable medium comprising instructions that, upon execution by the processor, perform operations comprising
receive imaging data of an image area, wherein the imaging data is thermal magnetic resonance imaging data in k-space generated at less than the Nyquist rate;
minimize a cost function based on an image estimate and the received imaging data; and
define an image of the image area based on the minimized cost function.

2. The system of claim 1, further comprising a magnetic resonance imaging machine configured to generate the imaging data of the image area.

3. A computer-readable medium comprising computer-readable instructions therein that, upon execution by a processor, cause the processor to perform image reconstruction of undersampled image data, the instructions configured to cause a computing device to:
receive imaging data of an image area, wherein the imaging data is thermal magnetic resonance imaging data in k-space generated at less than the Nyquist rate;
minimize a cost function based on an image estimate and the received imaging data; and
construct an image of the image area based on the minimized cost function.

4. A method of performing Image reconstruction of undersampled image data, the method comprising:
(a) receiving imaging data of an image area, wherein the imaging data is thermal magnetic resonance imaging data in k-space generated at less than the Nyquist rate;
(b) minimizing a cost function based on an image estimate and the received imaging data; and
(c) defining an image of the image area based on the minimized cost function.

5. The method of claim 4, further comprising:
(d) receiving second imaging data of the image area after receiving the imaging data, wherein the second imaging data is thermal magnetic resonance imaging data in k-space generated at less than the Nyquist rate;
(e) minimizing a second cost function based on an image estimate, the received imaging data, and the received second imaging data; and
(f) defining a second image of the image area based on the minimized second cost function.

6. The method of claim 5, wherein the image is defined before receiving the second imaging data.

7. The method of claim 4, wherein the received imaging data defined for a first time comprises the imaging data obtained for the first time and a summation of the imaging data received at one or more previous times to form a full k-space of the image area.

8. The method of claim 7, repeating (a)-(c) for a second time to support monitoring of a temperature of at least a portion of the image area, wherein the second time occurs after the first time.

9. The method of claim 7, wherein the received imaging data defined for the first time further comprises the imaging data obtained for a second time, wherein the second time occurs after the first time.

10. The method of claim 4, further comprising, before (a);
receiving second imaging data of the image area, wherein the second imaging data is thermal magnetic resonance imaging data in k-space generated at the Nyquist rate; and
initializing the cost function based on the received second imaging data.

11. The method of claim 4, further comprising, before (b), initializing the cost function using a sliding window technique.

12. The method of claim 4, wherein minimizing the cost function comprises applying an iterative gradient descent method.

13. The method of claim 12, wherein the iterative gradient descent method comprises iteratively updating the image data according to \tilde{m}^{m+1}=\tilde{m}^{o}−λC⁺( m̅), where n represents an iteration number, λ is a step size of a gradient descent method, and C⁺(\tilde{m}) is an Euler-Lag range derivative of the cost function.

14. The method of claim 4, wherein the cost function comprises a data fidelity term and a constraint term.

15. The method of claim 14, wherein the data fidelity term comprises ∥WF\tilde{m}−d′∥₂² wherein W represents a binary sparsifying pattern used to obtain the received imaging data, F represents a Fourier transform, \tilde{m} represents the image estimate, d′ represents the received imaging data, and [symbol] represents the L2 norm.

16. The method of claim 14, wherein the constraint term comprises α₁Ψ(\tilde{m}), wherein α₁ is a weighting factor, \tilde{m} represents the image estimate, and Ψ(\tilde{m}) is a constraint.

17. The method of claim 16, wherein the constraint comprises
$${\sum ∇ \text{?} m \text{?} ‖}_{2}^{2} , \\ \text{?} \text{indicates text missing or illegible when filed}$$
wherein N is the number of pixels in a time frame, ∇, is a temporal gradient operator, and \tilde{m}ᵢ is the i^{th} pixel of the image estimate over time, and [symbol] represents the L2 norm.

18. The method of claim 16, wherein the constraint comprises
$$\sum \text{?} \sqrt{{( {∇}_{r} \tilde{m} \text{?} )}^{2} + {β}^{2}} \text{?} , \\ \text{?} \text{indicates text missing or illegible when filed}$$
wherein N is the number of pixels in a time frame, ∇, is a temporal gradient operator, and \tilde{m}ᵢ is the i^{th} pixel of the image estimate over time, β is a small positive constant, and [symbol] represents the L1 norm.

19. The method of claim 4, further comprising calculating a thermal dose of at least a portion of the image area and presenting the calculated thermal dose to support monitoring of a temperature of at least a portion of the image area.

20. The method of claim 4, further comprising calculating a temperature change of at least a portion of the image area and presenting the calculated temperature change to support monitoring of a temperature of at least a portion of the image area.
